(19) United States
(12) Patent Application Publication
(10) Pub. No.: US 2007/0052671 A1
(43) Pub. Date: Mar. 8, 2007

(54) Pixel element actuation

(75) Inventor: Winthrop D. Childers, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/218,801

(22) Filed: Sep. 2, 2005

(51) Int. Cl. G09G 3/34

(52) U.S. Cl. 345/108

(57) ABSTRACT

Various embodiments of a method and apparatus for actuating pixel elements are disclosed.

### BACKGROUND

Some electronic devices include displays that employ liquid crystals. These displays may consume relatively large amounts of power, potentially rendering such displays unsuitable for portable devices.

### BRIEF DESCRIPTION OF THE DRAWINGS

FIG. 1 is a schematic illustration of one example embodiment of an electronic device having a pixel array according to one example embodiment.

FIG. 2 is an enlarged fragmentary front plan view schematically illustrating one embodiment of the pixel array of FIG. 1 according to an example embodiment.

FIG. 3 is an enlarged fragmentary top plan view schematically illustrating another embodiment of the pixel array of FIG. 1 according to an example embodiment.

FIG. 4A is a fragmentary sectional view schematically illustrating pixel elements of a pixel in a first discreet state according to an example embodiment.

FIG. 4B is a fragmentary sectional view schematically illustrating the pixel elements of FIG. 4A actuated to second discreet states according to an example embodiment.

FIG. 5 is a block diagram schematically illustrating one example of a controller of the electronic device of FIG. 1 according to an example embodiment.

FIG. 6 is a flow diagram illustrating one example of a process for selecting between a static mode and a modulating mode according to an example embodiment.

FIG. 7 is a flow diagram illustrating one example of a process for grouping pixels into super pixels according to an example embodiment.

FIG. 8 schematically illustrates examples of differently sized super pixels according to an example embodiment.

### DETAILED DESCRIPTION OF EXAMPLE EMBODIMENTS

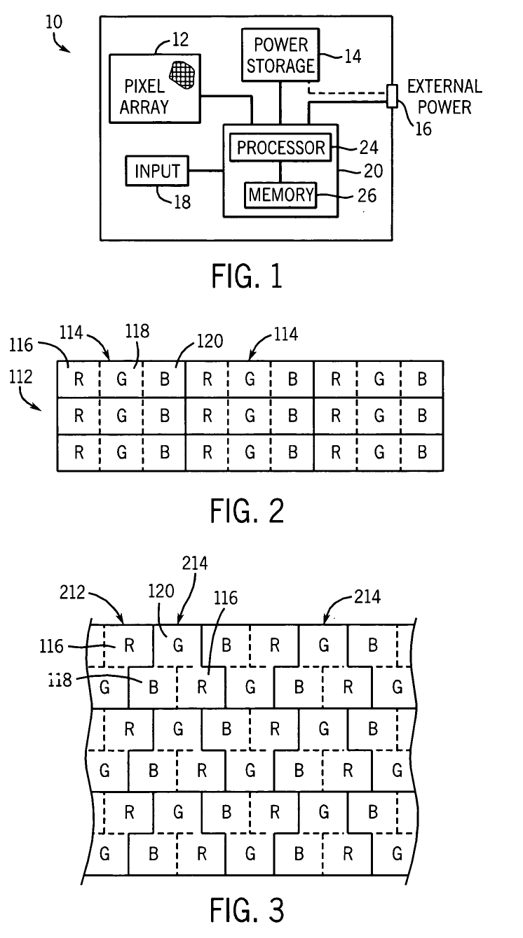

FIG. 1 is a schematic illustration of one example of an electronic device 10 which is configured to display an image. The image may include text such as alphanumeric symbols and the like, graphics or a combination thereof. In one embodiment, electronic device 10 constitutes a portable device such as a cell phone, a personal data assistant (PDA), a music player, a hand-held game player, a photo display device, a camera and the like. In still other embodiments, electronic device 10 may be more stationary in nature. Electronic device 10 displays images at a desired quality-level while conserving power.

Electronic device 10 generally includes pixel array 12, power storage device 14, external power interface 16, input 18 and controller 20. Depending upon its particular configuration and function, electronic device 10 may include additional elements or components. For example, depending on whether electronic device 10 constitutes a cell phone, personal data assistant, portable gaming device, digital camera, camcorder, DVD player/display, music player and the like, electronic device 10 may have additional components.

Pixel array 12 constitutes an array of multiple pixels configured to be selectively actuated to reflect visible light at selected wavelengths to form and display an image including one or both of graphics and text. The image or portions thereof may be stationary or may exhibit motion or animation. Although pixel array 12 is illustrated as being rectangular, pixel array 12 may have any of a variety of sizes and shapes.

FIG. 2 illustrates pixel array 112, one example of pixel array 12. As shown by FIG. 2, pixel array 112 includes multiple pixels 114 arranged adjacent to one another. Each pixel 114 includes discrete pixel elements 116, 118 and 120. Pixel elements 116,118 and 120 of each pixel 114 are actuatable that is, capable of being actuated to change between discrete states. In the particular example illustrated, pixel element 116 is actuatable between a black state in which little if any visible light is reflected from element 116 such that pixel element 116 has the appearance of black and a red state in which light reflected from element 116 has a wavelength in a red portion of the spectrum of visible light. Similarly, pixel element 118 is actuatable between a black state and a green state in which visible light reflected from element 118 has a wavelength in a green portion of the visible spectrum. Pixel element 120 is actuatable between a black state and a blue state in which visible light reflected from element 120 has wavelengths within a blue portion of the visible spectrum. Because elements 116, 118 and 120 are actuatable between discrete states, precise control over the color of light reflected from elements 116, 118 and 120 may be achieved. Although elements 116, 118 and 120 are described as being actuatable between a first black state and a second state in which light of one of the primary colors, red, green and blue, is reflected, elements 116, 118 and 120 may alternatively be configured to be actuated to change to discrete states in which other colors of visible light are reflected. For example, elements 116, 118 and 120 may alternatively be actuated to change to states wherein cyan, magenta and yellow light is reflected in lieu of red, green and blue light. In lieu of each of elements 116, 118 and 120 being actuatable to a common black state, elements 116, 118 and 120 may alternatively be actuatable to different discrete states in which different colors of visible light are reflected in lieu of black.

FIG. 3 schematically illustrates pixel array 212, another embodiment of pixel array 12 shown in FIG. 1. Pixel array 212 is similar to pixel array 112 (shown in FIG. 2) except that pixel array 212 includes pixels 214 in lieu of pixels 114. Like pixels 114, pixels 214 include pixel elements 116, 118 and 120. However, pixels 214 arrange pixel elements 116, 118 and 120 in a different configuration. In particular, pixel elements 114, 116 and 118 are arranged in a staggered or offset relationship with respect to one another as compared to pixel elements 116, 118 and 120 of pixels 114 which are arranged in aligned columns and rows. Because pixel elements 116, 118 and 120 are staggered in pixels 214, visible artifacts may be reduced. In still other embodiments, pixel array 12 (shown in FIG. 1) may have other arrangements of pixel elements 116, 118 and 120.

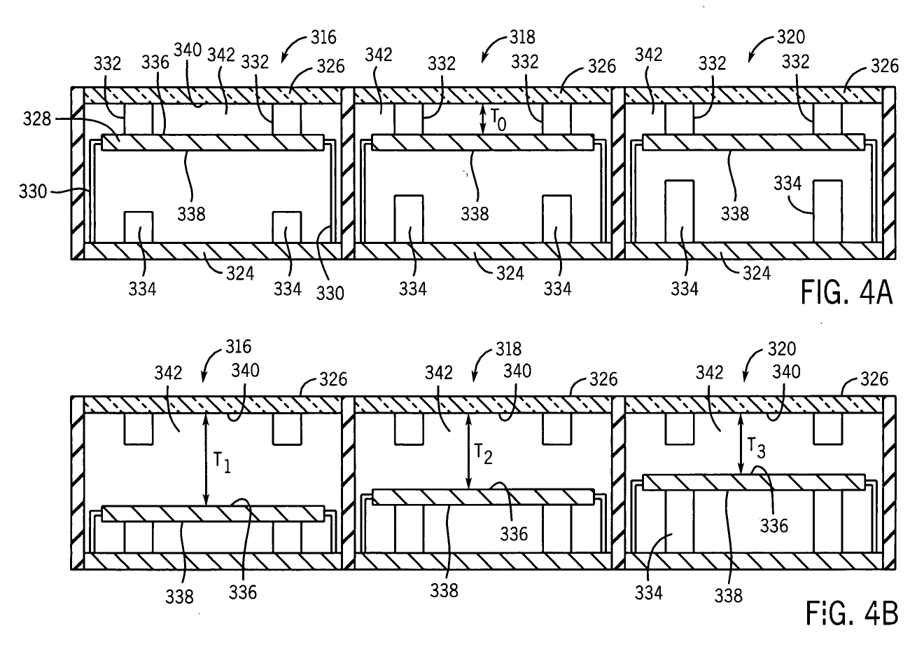

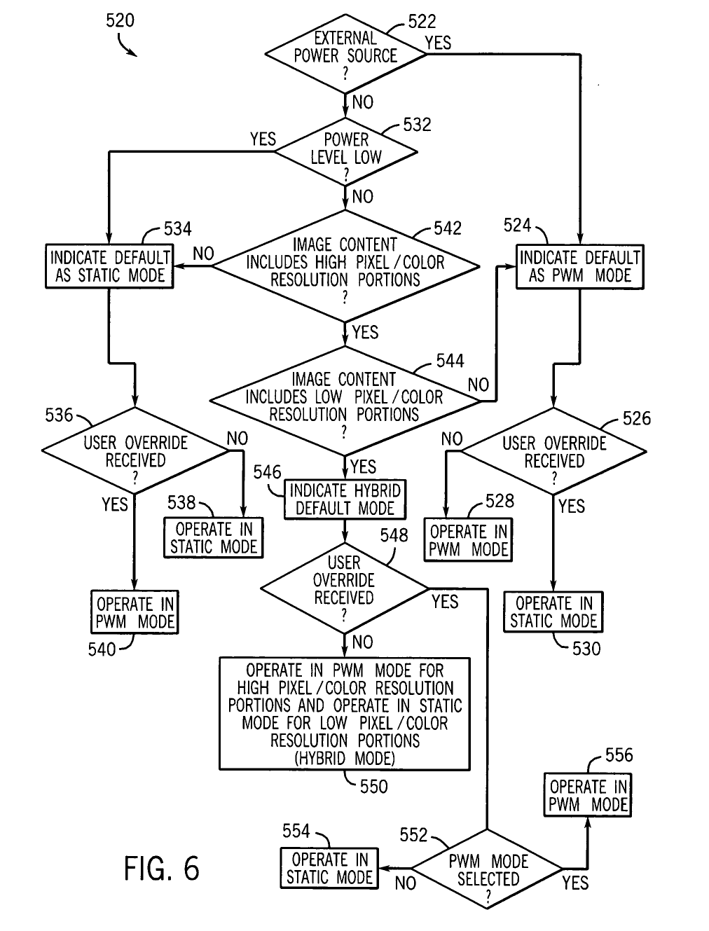

FIGS. 4A and 4B schematically illustrate pixel elements 316, 318 and 320, one example of pixel elements 116, 118 and 120, respectively. FIG. 4A illustrates pixel elements 316, 318 and 320 in a first common discrete black state while FIG. 4B illustrates pixel elements 316, 318 and 320 in their different discrete colored light-reflecting states. As shown by FIGS. 4A and 4B, each of pixel elements 316, 318 and 320 includes a bottom capacitor plate 324, a top reflector plate 326, a bottom or intermediate reflector plate 328, flexures 330 and discrete state position locators 332, 334. Bottom capacitor plate 324 of each pixel element 316, 318 and 320 forms a bottom plate of an electrostatic capacitor configured to deflect intermediate reflector 328. Bottom capacitor plate 324 is formed from one or more layers of electrically conductive material. In one embodiment, bottom capacitor plate 324 is formed from TaAl. In other embodiments, plate 324 may be formed from other materials.

Top reflector 326 constitutes a partially transparent or partially reflective, generally static or stationary top plate. Top reflector 326 cooperates with intermediate reflector 328 to form an interferometric optical cavity therebetween. In one embodiment, top reflector 326 may be formed from TaAl. In other embodiments, top reflector 326 may be formed from other materials.

Intermediate reflector 328 constitutes a highly reflective, electrically conductive plate movably supported between bottom capacitor plate 324 and top reflector 326. Intermediate reflector 328 cooperates with top reflector 326 to form the optical interferometric cavity and to reflect light that has passed through reflector 326. In one embodiment, intermediate reflector 328 may be formed from one or more layers of electrically conductive material such as AlCu, Al, Ag, Au and then alloys wherein an uppermost surface of layer 26 facing top reflector 326 is formed from a highly reflective material. In other embodiments, reflector 328 may be found from other materials.

Flexures 330 constitute structures configured to movably support intermediate reflector 328 for movement between its two discrete states. In one embodiment, flexures 330 are formed from a resiliently flexible structure formed from a material such as TaAl. In other embodiments, other materials may be utilized. In one embodiment, each intermediate plate 328 is movably supported by four equidistantly spaced flexures 330 positioned about reflector 328. In other embodiments, flexures 330 may have other configurations and may movably support reflector 328 at other locations.

Position locators 332 and 334 extend on opposite ends or sides of the interferometric optical cavity formed between top reflector 326 and intermediate reflector 328. Locators 332 and 334 serve as positive location identifying stops against which reflector 328 contacts and abuts in either of its two discrete positions or states. In the particular example illustrated, locators 332 constitute bumps, projections or protrusions extending below reflector 326 and configured to contact or abut upper surface 336 of intermediate reflector 328 when intermediate reflector 328 is in the raised discrete state shown in FIG. 4A. Locators 332 have a length or are otherwise configured such that when intermediate reflector 328 is positioned in contact against locators 332, as shown in FIG. 4A, the upper reflective surface 338 of reflector 328 is spaced from lower surface 340 of top reflector 326 such that optical cavity 342 has a thickness To. In one embodiment, dimension To has a value such that visible white light passing through top reflector 326 and reflected off of intermediate reflector 328 is largely absorbed in optical cavity 342. Thus, substantially no visible light is reflected from the pixel element and the optical cavities in FIG. 4A are in what may be referred to as a “black state”. In one particular embodiment, locators 332 are configured such that dimension T₀ shown in FIG. 4A is less than or equal to about 2000 Angstroms and nominally about 1,000 Angstroms or less. As noted above, in other embodiments, in lieu of each of locators 332 of each of pixel elements 316, 318 and 320 having the same length such that each of elements 316, 318 and 320 is actuatable to a common black state as shown in FIG. 4A, in other embodiments, locators 332 of pixel elements 316, 318 and 320 may have differing lengths such that elements 316, 318 and 320 are actuated to different states in which light having different wavelengths is reflected from such elements when reflectors 328 are actuated against locators 332.

Locators 334 extend from bottom capacitor plate 324 between bottom capacitor plate 324 and surface 338 of intermediate reflector 328. In the particular example illustrated, locators 334 and each of pixel elements 316, 318 and 320 are configured to abut or contact a lower surface 338 of intermediate reflector 328 to limit further movement of reflector 328 towards capacitor plate 324 so as to define a second discrete state or positioning of intermediate reflector 328 relative to top reflector 326. In the particular example illustrated, locators 334 of pixel elements 316, 318 and 320 establish different discrete states or positions of intermediate reflector 328 such that the optical cavities of partial reflectors 316, 318 and 320 and the light reflected from pixel elements 316, 318 and 320 has a different wavelength. As shown by FIG. 4B, in the particular example illustrated, locator 334 of pixel element 316 abuts surface 338 of intermediate reflector 328 such that surface 336 of reflector 328 is spaced from surface 340 of top reflector 326 such that optical cavity 342 of pixel element 316 has a dimension or thickness T₁. In the particular example illustrated, the distance T₁ has a value such that light passing through top reflector 326, reflecting off of surface 336 of intermediate reflector 328 and once again exiting element 316 has a wavelength of between about 6000 and about 7000 Angstroms so as to be in the red portion of the visible spectrum. According to one embodiment, thickness T₁ has a thickness of between about 3000 Angstroms and 3500 Angstroms and nominally about 3,250 Angstroms.

Locators 334 of pixel element 318 have a height or are otherwise configured so as to abut or contact surface 338 of intermediate reflector 328 such that surface 336 of reflector 328 is spaced from surface 340 of top reflector 326 such that optical cavity 342 of element 318 has a dimension or thickness T₂. The thickness T₂ of optical cavity 342 is chosen such that light passing through top reflector 326, reflected off of surface 336 of intermediate reflector 328 and exiting pixel element 318 is in the green portion of the visible spectrum. In one embodiment, light emitted from pixel element 318 has a wavelength of between about 4900 and 5400 Angstroms. In one embodiment, the thickness T₂ of cavity 342 is between about 2450 and 2700 Angstroms and nominally about 2,500 Angstroms for first order green.

Locators 334 of pixel element 320 have a height or are otherwise configured so as to abut or contact surface 338 of intermediate reflector 328 so as to space surface 336 of intermediate reflector from surface 340 of top reflector 326 by a distance such that optical cavity 342 has a thickness or dimension T₃. The thickness T₃ is selected such that light passing through top reflector 326, reflected off of surface 336 of intermediate reflector 328 and emitted from pixel element 320 is in the blue portion of the visible spectrum. In particular, in one embodiment, light emitted from pixel element 320 has a wavelength of between about 4400 and 4800. In one embodiment, the thickness T₃ is between about 2200 and 2400 and nominally about 2,300 Angstroms for first order blue. As noted above, in other embodiments, optical cavities T₁, T₂ and T₃ may have other values such that pixel elements 316, 318 and 320 emit visible light having different wavelengths and/or different colors. In still other embodiments, in lieu of locators 332 having uniform heights while locators 334 have differing heights, locators 332 may have differing heights and locators 334 may have similar or uniform heights or extents.

In operation, intermediate reflector 328 is electrostatically biased against either locators 332 or locators 334 by applying appropriate electrical charges to plate 324, reflector 326 and intermediate reflector 328. For example, employing dual gapped electrostatic biasing, a voltage is applied between plate 324 and intermediate reflector 328 while top reflector 326 and reflector 328 are shorted. Intermediate reflector 328 is attracted towards plate 324 as this voltage is increased. Employing dual capacitor electrostatic biasing, a first voltage is applied between plate 324 and intermediate reflector 328. A second voltage is applied between intermediate reflector 328 and top reflector 326. Alternatively, a first voltage may be applied between plate 324 and intermediate reflector 328 while a second voltage is applied between plate 324 and top reflector 326. By appropriate application of voltages, intermediate reflector 328 may be attracted up towards top reflector 326 until contacting locators 332 or down towards plate 324 until contacted locators 334.

Referring once again to FIG. 1, power storage device 14 constitutes a device configured to store and supply power for the operation of at least portions of electronic device 10. In one embodiment, power storage device 14 may constitute a battery. In one embodiment, power storage device 14 may comprise a removable and replaceable battery. In another embodiment, the power storage device may comprise a permanent internal battery.

External power interface 16 constitutes a device configured to facilitate connection of electronic device 10 to an external power source or supply. For example, in one embodiment, interface 16 may be configured to facilitate electrical connection of electronic device 10 to a DC power source such as an AC to DC converter which is itself connected to an AC power source. In yet another embodiment, interface 16 may be configured to be directly connected to an AC power source. External power interface 16 enables electronic device 10 to be powered by the external power source. In one embodiment, external interface 16 may further be configured (as indicated by broken lines) to charge power storage device 14. In other embodiments, interface 16 or power storage device 14 may be omitted.

Input 18 constitutes one or more devices configured to interface with a user of electronic device 10. Input 18 is configured to permit a user of electronic device 10 to input date, instructions or commands to electronic device 10. According to one example embodiment, input 18 is configured to permit a user to input instructions or commands selecting a mode of operation by which pixel array 12 displays an image. In one embodiment, input 18 includes a keyboard or touchpad configured to facilitate manual input of commands. In yet another embodiment, input 18 may include a touch screen, push buttons, slider bars, a touchpad, a mouse, joystick, a microphone with associated voice recognition software programming, and the like. In still other embodiments, input 18 may be omitted.

Controller 20 constitutes one or more processing units configured to analyze or manipulate electrical signals or data and to generate control signals based upon instructions contained within a memory. In the particular example illustrated, controller 20 includes one or more processing units 24 and one or more memories 26. Processing unit(s) or processor 24 is configured to detect or otherwise determine the current or present source of power for electronic device 10, whether it be power storage device 14 or an external power source connected through interface 16. Processor 24 is further configured to detect or otherwise determine a level of existing power or energy level or charge state stored within power storage device 14. In other embodiments, processor 24 may be connected to another internal component that is configured to detect the level of power or charge state currently within power storage device 14. Processor 24 is further configured to receive signals from input 18 representing instructions from a user of electronic device 10. Processor 24, following instructions contained in memory 26, is further configured to analyze one or images to be formed by the pixels of pixel array 12 or to receive information or data pertaining to such images to be displayed by pixel array 12. Processor 24, following instructions contained in memory 26, is further configured to analyze one or more of the current source of power for electronic device 10, the level of power consumed or remaining in power storage device 14, any input commands received through input 18, and the content of an image to be formed by the pixels of pixel array 12 so as to select one or more modes of operating or actuating the pixel elements of the pixels of pixel array 12 between their discrete states.

For purposes of the disclosure, the term “processor unit” shall include a currently or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 20 is not limited to any specific combination of hardware circuitry and software, nor to any particular source for the instructions executed by the processing unit.

Memory 26 constitutes one or more persistent storage devices configured to store and allow retrieval of information. In the particular embodiment illustrated, memory 26 is configured to store instructions for directing processor 24 to analyze or manipulate signals, information or data received by controller 20 as well as to direct processor 24 to generate control signals directing and controlling actuation of pixel elements of pixel array 12 between their discrete states based upon one or more selected modes of actuation. In one embodiment, memory 26 may constitute an internal fixed memory associated with electronic device 10. In another embodiment, memory 26 may constitute an external memory source in communication with electronic device 10. In yet another embodiment, memory 26 may constitute a portable memory storage device removably inserted or connected to electronic device 10.

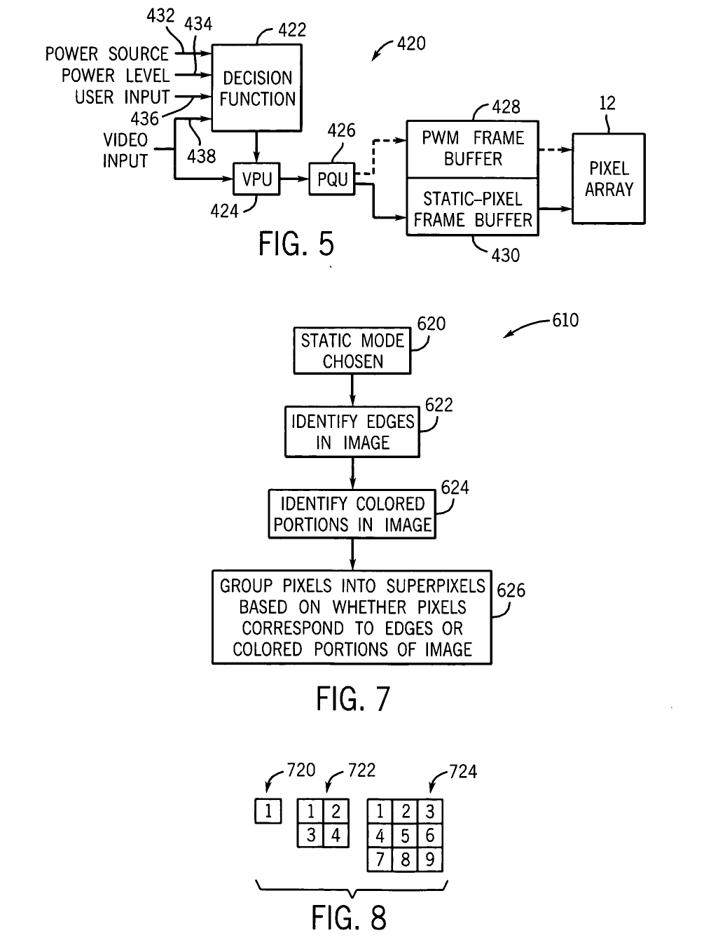

FIG. 5 is a schematic block diagram illustration of controller 420, one example of controller 20 of FIG. 1. Controller 420 includes decision function 422, video processing unit 424 (VPU), picture quality unit 426 (PQU), pulse width modulation (PWM) frame buffer 428 and static-pixel frame buffer 430. Decision function 422 includes electronics and is configured to follow instructions contained in memory 26 (shown in FIG. 1) so as to receive inputs such as information 432 identifying the current power source for electronic device 10, information 434 indicating the current level of remaining power within power storage device 14 or the amount of power from power storage device 14 (shown in FIG. 1) that is being consumed, information 436 representing user input or instructions received through input 18 (shown in FIG. 1) and information 438 representing one or more characteristics of an image to be formed and displayed by pixel array 12 (shown in FIG. 1). Based upon such inputs, decision function 422 determines or selects the mode of operation or a mode for actuating pixel elements, such as pixel elements 116, 118, 120 or 316, 318, 320, between their discrete states. For example, according to one mode of operation, pixel elements, such as pixel elements 116, 118, 120 or pixel elements 316, 316, 320, may be actuated to change between their discrete states (black and red, black and green and black and blue) using either a static mode or a modulating mode.

Under the static mode, pixel elements are statically retained in their discrete states or positions. For example, appropriate charges may be applied to one or more of capacitor plate 324, top reflector 326 and intermediate reflector 328 to electrostatically retain or hold intermediate reflector 328 in a first discrete state in which intermediate reflector 328 is held against locator 332, which results in the particular pixel element reflecting substantially no visible light in the particular example described, or a second state in which reflector 328 is electrostatically retained against locators 334 in which pixel element 316 reflects red light, in which pixel element 318 reflects green light and in which pixel element 320 reflects blue light. By appropriately controlling which pixel elements 316, 318 and 320 of pixel array 12 are statically retained in one of their two discrete states, an image having multiple colors may be formed by pixel array 12 (shown in FIG. 1). Images formed by statically retaining appropriate pixel elements 316, 318 and 320 or other pixel elements such as pixel elements 116, 118 and 120 in one of their discrete states may result in power consumption savings.

Under the modulating mode, pixel elements 116, 118, 120 or pixel elements 316, 318, 320 are modulated or moved back and forth between their discrete states. For example, with respect to pixel elements 316, 318 and 320, appropriate charges are applied to at least two of bottom capacitor plate 324, top reflector 326 and intermediate reflector 328 (depending upon the biasing scheme) to electrostatically move intermediate reflector 328 from a first position in which surface 336 abuts one or more of locators 332 to the second discrete position in which surface 338 of reflector 328 abuts one or more of locators 334 and vice-versa. In one embodiment, movement between these discrete states or positions is not paused or otherwise stopped, but is continuous during operation of pixel array 12. Once reflector 328 has moved against one of locators 332 and 334, it is temporarily retained against one of locators 332 and 334 until being once again moved towards the other of locators 332 and 334. The time during which reflector 328 is temporarily positioned against locators 332 and 334 before being moved towards the other of locators 332 and 334 and the rate or speed at which reflector 328 is moved back and forth between locators 332 and 334 is controlled or varied to vary the wavelengths of light emitted from the particular pixel elements 316, 318, 320. By varying or controlling the percentage of time during which pixel element 316 is in either its black state or its red state as compared to the percentage of time that pixel element 318 is in either its green state or black state and as compared to the percentage of time that pixel element 320 is in either its blue state or black state, the overall color provided by the pixel including elements 316, 318 and 320 may be precisely controlled to potentially achieve high levels of color gradient or resolution. As compared to the static mode, the modulating mode may achieve higher levels of color resolution. In addition, because such multiple levels of color may be provided by each individual pixel rather than by the combined effect of multiple pixels as in the static mode, the modulating mode also may provide higher image or pixel resolution. However, as compared to the static mode, because of the energy used to repeatedly modulate each pixel element 316, 318, 320 between its discrete states, energy consumption may be higher.

As noted above, decision function 422 selects either the static mode or the modulating mode for actuating pixel elements based upon various inputs. FIG. 6 is a flow diagram illustrating one example of operation or process 520 by which decision function 422 (shown in FIG. 5) of controller 20 (shown in FIG. 1) for selecting either the static mode or the modulating mode. As indicated by step 522, based upon information 432 in FIG. 5, decision function 422 of controller 420 (shown in FIG. 1) determines whether power to be used to actuate pixel array 12 (shown in FIG. 1) in either the static mode or the modulating mode will be supplied from an external power source such as power received through interface 16 (shown in FIG. 1).

As indicated by step 524, if power is to be supplied from an external power source, the pulse width modulating (PWM) mode is indicated to the user as a default. Such indication may be provided by controller 420 generating control signals causing pixel array 12 to form an image or text identifying the modulating mode (PWM mode) as the default mode or by controller 20 generating control signals directing some other indicator to communicate such information. For example, controller 420 may generate control signals directing or causing the illumination of a light-emitting diode indicating the selection of the modulating mode as a default mode. In one embodiment, if controller 420 generates control signals directing pixel array 12 to be used to indicate the modulating mode as the default mode, such indication may be provided by appropriately actuating pixels to change between their discrete states in the static mode to conserve power consumption since such information can be communicated without relatively high color or pixel resolution. In other embodiments, the communication of the default mode may be communicated by actuating pixel array 12 or by actuating pixel elements of pixel array 12 using the modulating mode.

As indicated-by step 526, once the modulating mode has been indicated to the user as the default mode, decision function 422 of controller 420 determines, based upon user input 436 (shown in FIG. 5) received through input 18 (shown in FIG. 1) whether the user has overridden the selected default mode. As indicated by step 528, if the user has not overridden the default modulating mode indicated in step 524, controller 420 (shown in FIG. 1) generates control signals causing pixel elements of pixel array 12 to be actuated between their discrete states using the modulating mode. Alternatively, as indicated by step 530, if the user has overridden the default modulating mode indicated in step 524, controller 420 generates control signals alternatively causing the pixel elements of pixel array 12 to be actuated between their discrete states using the static mode.

In one embodiment, input 18 and controller 420 may be configured to automatically proceed with step 528 and to deem that the default mode has not been overridden if no input is received for a predetermined period of time following notice provided in step 524. In yet another embodiment, controller 420 may alternatively be configured to generate control signals additionally requesting confirmation in step 524 and to automatically proceed according to step 530 unless a confirmation is received within a predetermined period of time following notice in step 524. In still another embodiment, controller 420 may be configured to pause until either an overriding command or a confirmation command is received by input 18 in step 526.

In yet other embodiments, the controller may alternatively be configured such that in step 524, the controller automatically begins generating control signals directing the pixel elements of pixel array 12 to actuate between their discrete states in the default modulating mode. In such an embodiment, the default mode in which electronic device 12 is operating may be additionally indicated to the user or such indication may be omitted where the user may determine the default mode that was selected for actuation of pixel array 12 by viewing the image formed by pixel array 12. In such an embodiment, the user may override the current modulating mode as indicated in step 526. Thereafter, controller 28 may operate in either mode per steps 528 and 530 depending upon whether user override has been received in step 526. In some embodiments, steps 526, 528 and 530 may be omitted, wherein controller 420 automatically operates in the default modulating mode.

As indicated by step 532, if decision function 422 of controller 420 determines from information 432 that electronic device 10 is not utilizing power from an external power source to actuate the pixel elements of pixel array 12 (shown in FIG. 1), controller 420 determines that such power is being provided by an internal power source such as a power storage device. Based upon information 434, the decision function 422 of controller 420 determines the current level of power remaining within the power storage device, such as power storage device 14 shown in FIG. 1. In one embodiment, controller 420 may determine the current level of power remaining in the power storage device 14 by sensing or receiving signals from another device that senses the existing level of power within power storage device 14. In yet another embodiment, controller 420 may determine the existing power level by tracking or otherwise determining the amount of power from power storage device 14 that has been previously consumed and subtracting this amount from a sensed, determined or predetermined starting or initial power level of storage device 14.

As indicated by step 534, if level of power storage device is low (i.e., the power level is below a pre-defined minimum value), controller 420 is indicated to the user a default. Such indication may be provided by controller 420 generating control signals causing pixel array 12 to form an image or text identifying the static mode as the default mode or by controller 20 generating control signals directing some other indicator to communicate such information. For example, controller 420 may generate control signals directing or causing the illumination of a light-emitting diode indicating the selection of the static mode as a default mode. In one embodiment, if controller 420 generates control signals directing pixel array 12 to be used to indicate the default static mode, such indication may be provided by appropriately actuating pixels to change between their discrete states in the static mode to conserve power consumption since such information can be communicated without relatively high color or pixel resolution. In other embodiments, the communication of the default mode may be communicated by actuating pixel array 12 or by actuating pixel elements of pixel array 12 using the static mode.

As indicated by step 536, once the static mode has been indicated to the user as the default mode, decision function 422 of controller 420 determines, based upon user input 436 (shown in FIG. 5) received through input 18 (shown in FIG. 1) whether the user has overridden the selected default mode. As indicated by step 538, if the user has not overridden the default static mode indicated in step 534, controller 420 (shown in FIG. 1) generates control signals causing pixel elements of pixel array 12 to be actuated to change between their discrete states using the static mode. Alternatively, as indicated by step 540, if the user has overridden the default static mode indicated in step 534, controller 420 generates control signals alternatively causing the pixel elements of pixel array 12 to be actuated to change between their discrete states using the modulating mode.

In one embodiment, input 18 and controller 420 may be configured to automatically proceed with step 538 and to deem that the default mode has not been overridden if no input is received for a predetermined period of time following notice provided in step 534. In yet another embodiment, controller 420 may alternatively be configured to generate control signals additionally requesting confirmation in step 534 and to automatically proceed according to step 540 unless a confirmation is received within a predetermined period of time following notice in step 534. In still another embodiment, controller 420 may be configured to pause until either an overriding command or a confirmation command is received by input 18 in step 536.

In yet other embodiments, the controller may alternatively be configured such that in step 534, the controller automatically begins generating control signals directing the pixel elements of pixel array 12 to actuate to change between their discrete states in the default static mode. In such an embodiment, the default mode in which electronic device 12 is operating may be additionally indicated to the user or such indication may be omitted where the user may determine the default mode that was selected for actuation of pixel array 12 by viewing the image formed by pixel array 12. In such an embodiment, the user may override the current static mode as indicated in step 536. Thereafter, controller 420 may operate in either mode per steps 538 and 540 depending upon whether user override has been received in step 536. In some embodiments, steps 536, 538 and 540 may be omitted, wherein controller 420 automatically operates in the default static mode.

As indicated by step 532, if controller 420, using information 434, determines that the power level of power storage device 14 is not low (i.e., the power level is above a predefined minimum value), controller 420 determines from information 438 whether the image content to be formed by pixel array 12 (shown in FIG. 1) includes high pixel/color resolution portions. For example, a high pixel resolution portion may constitute those portions of an image where greater image sharpness or precision is requested. In other words, the defined area of an image is represented by a greater density of corresponding pixels. Likewise, a high color resolution portion of an image may constitute those portions of an image having finer, more precise color changes or gradations or shades. As indicated by FIG. 6, if decision function 422 of controller 420 determines, in step 542, that the particular image to be formed by pixel array 12 does not include high pixel/color resolution portions such that the entire image includes relatively low pixel/color resolution portions, controller 420 selects the static mode as the default mode. Thereafter, controller 420 proceeds according to steps 534-540 as described above.

As indicated by step 544, if controller 420 has determined that the image to be displayed by pixel array 12 includes low pixel/color resolution portions or alternatively receives signals or information indicating to controller 420 that the image to be displayed includes low pixel/color resolution portions, controller 420 proceeds to determine whether the content of the image to be displayed by pixel array 12 (shown in FIG. 1) also includes low pixel/color resolution portions. For example, the image to be displayed may additionally include a portion that has a low resolution portion where a defined area of the image may be sufficiently formed or represented by a corresponding lower density of pixels (low pixel resolution). In addition or alternatively, a portion of the image to be formed by pixel array 12 may include fewer colors, fewer shades of color or larger differences between colors (a low color resolution). Examples of low pixel/color resolution portions may include a single color background to a high pixel/color resolution portion of an image or text (i.e., alphanumeric symbols and the like). As indicated by FIG. 6, if decision function 422 of controller 420 determines that or receives signals indicating that the image to be displayed by pixel array 12 does not include low pixel/color resolution portions such that the entire image to be displayed includes high pixel/color resolution portions, decision function 422 of controller 420 selects the pulse width modulating mode as the default mode and proceeds according to steps 524-530 as described above.

As indicated by step 546, if decision function 422 of controller 420 determines or otherwise receives signals indicating that the image to be displayed by pixel array 12 (shown in FIG. 1) also includes low pixel/color resolution portions in addition to high pixel/color resolution portions, controller 420 selects a hybrid mode as the default operating mode for actuating pixel elements of pixel array 12 between their discrete states. As further indicated by step 546, controller 420 indicates to a user of electronic device 10 the selection of the hybrid mode as the default mode. Such indication may be provided in a manner similar to that described above with respect to either step 524 or step 534. For example, controller 420 may generate control signals directing pixel array 12 to display text indicating the selected hybrid mode. In another embodiment, controller 420 may generate control signals directing a light or LED adjacent printed text indicating a hybrid mode to be lit. In yet another embodiment, controller 420 may generate control signals causing LEDs adjacent to both a static mode label and a modulating mode label to be lit.

As indicated by step 548, once the hybrid mode has been indicated to the user the default mode, decision function 422 of controller 420 determines based upon user input 436 (shown in FIG. 5) received through input 18 shown in (FIG. 1) whether the user has overridden the selected default mode.

As indicated by step 550, if controller 420 has not received a user override via input 18 (shown in FIG. 1) or if controller 420 has received confirmation or instructions to proceed according to the selected default mode per information 436 (shown in FIG. 5), controller 420 generates control signals actuating the pixel elements of pixel array 12 to operate in the hybrid mode. In particular, controller 420 generates control signals causing actuation of particular pixel elements of those pixels corresponding to the high pixel/color resolution portions of the image to be actuated to change between their respective discrete states in the modulating mode. Likewise, controller 420 generates control signals causing the pixel elements of pixels corresponding to the low pixel/color resolution portions of the image to be actuated to change between their discrete states using the static mode. For example, in one scenario, an image may include a solid colored background or frame (low pixel resolution) about a multi-colored detailed graphic (color photograph) (high pixel/resolution) and may additionally include a caption of text (low pixel/color resolution). In such a scenario, controller 420 may generate control signals such that the pixel elements of pixels representing the frame are actuated to operate in the static mode, the pixel elements of pixels representing the graphic are actuated to operate in the modulating mode and the pixel elements of pixels representing the caption are actuated in the static mode.

As indicated by step 552, if decision function 422 of controller 420 receives information 436 indicating the user has overridden the default hybrid mode, controller 420 further analyzes information 436 to determine whether the pulse width modulating mode has been selected by the user and inputted through input 18. As indicated by step 554, if controller 420 determines from information 436 that the modulating mode has not been selected in step 552, decision function 420 selects the static mode as the mode of actuating pixel elements of pixel array 12 to change between the discrete states for all pixels of an image to be formed by pixel array 12. As indicated by step 556, if decision function 422 determines from information 436 that the user has selected the pulse width modulating mode, decision function 422 selects the modulating mode as the mode for actuating the pixel elements of all the pixels for the image to change between their respective discrete states. In another embodiment, decision function 422 may alternatively determine whether the user has selected the static mode in step 552. In such an embodiment, if the user has not selected the static mode, controller 420 will operate in the pulse width modulating mode. If the static mode has been selected, controller 420 will operate in the static mode.

Overall, because controllers 20 and 420 are configured to select from multiple modes for actuating pixel elements of pixel array 12 to change between their discrete states based upon input or determined factors, the displaying of images by pixel array 12 may provide enhanced image quality with efficient power consumption. Because controllers 20 and 420 select between the static mode and the modulating mode based upon whether an external power source is supplying power, the pixel elements may be actuated to change between their discrete states in the modulating mode to provide a relatively high level of image quality when power consumption may not be a concern such as when electronic device is being supplied with power from an external power source such as an electrical outlet. At the same time, if power is being supplied from an internal power storage device, decision function 422 of controller 420 may prolong the use of electronic device 10 without recharging or replacing the power storage device by actuating the pixel elements of pixel array 12 in the static mode when the level of power in the power storage device is low. Process 520 carried by controller 20 or controller 420 further enhances image quality while facilitating efficient use of power by selecting between the static mode and the modulating mode based upon the particular characteristics of the image being displayed. For example, if the image would be better displayed with high pixel or color resolution, the pixels are actuated in the modulating mode. If satisfactory image quality may be provided for an image using the static mode, controller 20 or controller 420 selects the static mode to conserve power. In those circumstances where an image includes both high pixel/color resolution portions and lower pixel/color resolution portions, controllers 20 and 420 generate control signals such that pixels are actuated in both modes to provide satisfactory image quality while conserving power. At the same time, process 520 permits a user to override the selected default mode based upon his or her desired mode.

In other embodiments, decision function 422 of controller 420 or controller 20 may alternatively select between the static mode and the modulating mode using other factors or using fewer factors. For example, in another embodiment, decision function 422 of controller 420 or controller 20 may alternatively be configured to operate by default in the power-saving static mode at all times unless a specific input or instruction command is received from a user of the device requesting the modulating mode or requesting a higher quality image with higher pixel/color resolution. In such an embodiment, controller 20 or 420 may alternatively be configured to operate in the modulating mode for a predetermined period of time after the user request is made before returning to the default static mode. In still other embodiments, other criteria or combinations of criteria may be used to select between the static and the modulating mode.

Referring once again to FIG. 5, once decision function 422 of controller 420 has selected the static mode, the modulating mode or the hybrid mode, its decision is communicated to video processing unit 424. Video processing unit 424 constitutes electronics of processor 24 configured to de-compress and scale or resize video or image data or information 438 received either directly from video input or received through decision function 422. Video processing unit 424 scales or resizes image data to the size and density of pixel array 12 (shown in FIG. 1). Video processing unit 424 further bases its scaling or resizing of the image based upon the selected mode for actuating the pixel elements of the pixels.

Picture quality unit 426 constitutes electronics of processor 24 configured to perform various tasks such as color space conversion (for example, YCbCr to RGB) into GAMMA. In addition, picture quality unit 426 may perform various error diffusion techniques upon the image data received from video processing unit 424.

After the image data has been processed by picture quality unit 426, such image data is transmitted to either or both of the pulse width modulating frame buffer 428 or the static pixel frame buffer 430. Buffer 428 constitutes electronics provided as part of processor 24 configured to re-format image data from picture quality unit 426 into bit-plane format to facilitate pulse width modulation generation of colors. Each bit plane is manifested on pixel array 12 during one or more time slices. For one frame of data, the associated bit planes are all manifested on the pixel array 12 during a frame period. In one embodiment, the more significant (longer duration) bit planes are not each displayed during contiguous time periods but temporarily split and manifested during time slices that are each distributed over the frame period. The following table depicts bit planes for each primary color.

| Bit Plane | Duration/Time Slice | # Slices | Weighting |
|---|---|---|---|
| 0 | 1 | 1 | 1 |
| 1 | 2 | 1 | 2 |
| 2 | 4 | 1 | 4 |
| 3 | 8 | 1 | 8 |
| 4 | 16 | 1 | 16 |
| 5 | 16 | 2 | 32 |
| 6 | 16 | 4 | 64 |
| 7 | 16 | 8 | 128 |

The binary number for each color value determines which bit planes are on. Each bit plane represents a portion of the frame period during which a particular primary color pixel element is on for each pixel. For example, for the number 11111111, all bit planes are on. For 00000001, only bit 0 is on and the remaining bits are off. Most significant bits 5-7 are divided up into time slices that are temporally spaced across the frame. In the particular example illustrated, the weighting of such bits is binary and is proportional to the per-pixel contribution to the average intensity during a frame period when that pixel is turned on. For the particular example of a 60 Hertz frame rate, a least significant bit time slice has a duration of approximately 65 microseconds. The duration of the least significant bit can be increased by utilizing spatial dithering (checkerboard pattern) or temporal dithering (displaying a bit plane every other frame) so that fewer time slices are used during a given frame period.

In one example, for each primary color, the time slice sequence generated by buffer 428 is: S7, S6, S7, S5, S7, S6, S7, S5, S7, S6, S7, S6, S7, S4, S7, S4, S3, S2, S1, S0. These sequences of time slices for each of the primary colors red, green and blue occur in parallel. In other embodiments, each primary color may have its own distinct sequence.

Overall, by breaking the time period during which a particular pixel element is to be in one of its discrete states, for example, the time period during which pixel element 316 is to be in its red state, into slices and by breaking up the bit plane also into slices and interleaving such slices, visible artifacts in the display formed by pixel array 12 may be reduced. In addition, by reformatting the image data into bit plane format for pulse width modulation of the pixel elements, the modulation of pixel elements between their discrete states may be synchronized with the modulation of other pixel elements to facilitate achieving a desired level of control of the colors and images being formed. In other embodiments, buffer 428 may reformat image data into other formats for facilitating pulse width modulation of the pixel elements. In still other embodiments, an analog function may be used to modulate pixel elements based upon a binary number associated with the particular pixel rather than the data synchronized in a bit plane.

Buffer 430 maps image data into a binary number based upon pre-selected thresholds based upon grouping of pixels as determined by decision function 422 when the static mode has been selected. FIG. 7 is a flow diagram of one example of a process 610 that may be performed by decision function 422 upon the selection of the static mode for an image or portions of an image as indicated by step 620. As indicated by step 622, decision function 422 identifies or receives information identifying the edges in the image to be formed by pixel array 12 (shown in FIG. 1). As indicated by step 624, decision function 422 further identifies or otherwise receives information indicating those portions in the image that have colors that would be best presented with colors other than colors that may be provided by a single pixel, i.e., red, green, blue, black, white, black, a combination of red and green, the combination of red and blue and the combination of green and blue (i.e. higher color resolution). In other embodiments where light reflected from the pixel elements have colors other than red, green and blue, the potential colors that may be provided by such elements in a single pixel may also vary.

As indicated by step 626, decision function 422 further groups pixels into individual pixels or super-pixels based upon whether such pixels correspond to the identified edges or the identified higher color resolution portions of an image.

As shown by FIG. 8, the pixels of pixel array 12 (shown in FIG. 1) may be alternatively grouped in an advantageous way including a single pixel 720, super-pixels 722 including 4 pixels, super-pixels 724 including 9 pixels and so on. According to one example embodiment, decision function 422 groups those pixels of an image that correspond to higher resolution colored portions of an image into larger super-pixels such as super-pixel 724. Stated another way, larger array super-pixels are utilized to define gradually changing portions of an image where color accuracy and shading are the desirable or valued attributes. For those pixels in an image that correspond to edge portions or regions, such as an edge of a graphic or an edge of a text or number, where color accuracy or precise control of color may not be as large a factor in image quality, decision function 422 groups such pixels into smaller super-pixels such as super-pixels 722 or single-pixel 720. Stated another way, smaller-super pixels or individual pixels are utilized to define sharp transitions in an image where defining a sharp edge or transition is a desirable or valued visual attribute. As a result, decision function 422 groups pixels into larger super-pixels and maps image data or portions of an image to such larger super-pixels for those portions of an image which may most benefit from enhanced color control. By grouping those pixels corresponding to edges of an image into smaller sized super-pixels such as super-pixels 722 or 720, decision function 422 provides sharper edges as compared to other portions of the image which have larger super-pixels such as super-pixel 724.

Referring once again to FIG. 5, based upon the size of such super-pixels 720, 722, 724, buffer 430 maps the image into a binary number based upon pre-selected thresholds. For example, with respect to super-pixel 720 including a single pixel, buffer 430 assigns a binary number to each pixel element of the single pixel forming super-pixel 720. Static mapping for a single-pixel 720 is as follows:

| Binary Number | # Pixel elements in ON State |
|---|---|
| 0-127 | OFF |
| 128-253 | ON |

For a 2×2 array or grouping of pixels such as with super-pixel 722, buffer 430 assigns a binary number for each pixel element type. In other words, buffer 430 assigns a binary number which is used to control how many of the 4 pixel elements 316 and super-pixel 722 are in either the ON red state or the OFF black state, how many of the 4 green pixel elements 318 of super-pixel 722 are in the green ON state or the black OFF state and how many of the 4 blue pixel elements 320 (shown in FIG. 4A) of super-pixel 722 (shown in FIG. 8) are in the blue ON state or the black OFF state. The number of pixel elements in each super-pixel 722 to be in the ON state may be determined from an average of the binary numbers associated with each of the 4 pixels of super-pixel 722 as follows:

| Average Binary Number | # Pixel elements in ON State |
|---|---|
| 0-49 | 0 |
| 50-99 | 1 |
| 100-149 | 2 |
| 150-199 | 3 |
| 200-253 | 4 |

In other embodiments, other mapping schemes may be utilized to control the number of pixel elements that are statically retained in either the ON or OFF states. Although mapping of pixels has been described as being performed in buffer 430, in other embodiments, such mapping may alternatively be performed in picture quality unit 426.

Upon the reformatting of image data into bit plane format or binary numbers in buffers 428 and 430, such image data is stored until ready for display by pixel array 12 (shown in FIG. 1). As shown by FIG. 5, such binary numbers are utilized by controller 20 or controller 420 as control signals to direct actuation of the pixel elements of pixel array 12 to operate in either the static mode or the modulating mode.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
pixels having interferometric elements actuatable between states; and
a controller configured to actuate the elements to change between a modulating mode and a static mode.

2. The apparatus of claim 1, wherein the controller is configured to select either the modulating mode or the static mode based upon at least a source of power for the apparatus.

3. The apparatus of claim 2, wherein the controller is configured to select the modulating mode in response to the apparatus receiving power from an external source.

4. The apparatus of claim 2, wherein the controller is configured to select the static mode in response to the apparatus receiving power from an internal source.

5. The apparatus of claim 1, wherein the controller is configured to select either the modulating mode or the static mode based upon at least a level of power in a power storage device.

6. The apparatus of claim 1, wherein the controller is configured to select either the modulating mode or the static mode-based upon at least a content of an image to be displayed by the pixels.

7. The apparatus of claim 6, wherein the controller is configured to select the static mode in response to the image including low pixel or color resolution portions.

8. The apparatus of claim 6, wherein the controller is configured to select the modulating mode in response to the image including high pixel or high color resolution portions.

9. The apparatus of claim 6, wherein the controller is configured to operate in a hybrid mode in which the controller actuates a first portion of the pixels in the static mode and a second portion of the pixels in the modulating mode.

10. The apparatus of claim 9, wherein the controller is configured to select the hybrid mode in response to a first portion of an image to be formed by the first portion of the pixels including low pixel or low color resolution and a second portion of the image to be formed by the second portion of the pixels including a high pixel or high color resolution.

11. The apparatus of claim 1, wherein the controller is configured to group pixels into super-pixels based at least upon a content of an image to be formed by the pixels.

12. The apparatus of claim 11, wherein the controller is configured to group pixels forming an edge in the image into a first group having a first size and to group pixels not forming the edge in the image into a second group having a second larger size.

13. The apparatus of claim 11, wherein the controller is configured to group pixels forming a first color resolution portion of an image into a group having a first size and to group pixels forming a second greater color resolution portion of the image to a second group having a second larger size.

14. The apparatus of claim 1, wherein the controller is configured to actuate the elements to operate in the static mode by default until receiving user input to actuate the elements to operate in the modulating mode.

15. The apparatus of claim 1, wherein the controller is configured to selectively actuate the elements to change between the states in the modulating mode at a first rate and a second greater rate.

16. The apparatus of claim 15, wherein the controller is configured to select the first rate and the second rate based at least upon a source of power for the apparatus.

17. The apparatus of claim 15, wherein the controller is configured to select the first rate and the second rate based at least upon a level of power in a power storage device.

18. The apparatus of claim 15, wherein the controller is configured to select the first rate and the second rate based at least upon content of an image to be displayed by the pixels.

19. The apparatus of claim 15, wherein the controller is configured to actuate elements of a first portion of the pixels at the first rate and elements of a second portion of the pixels at the second rate.

20. The apparatus of claim 1, where in the controller is configured to reformat image data into bit plain format when in the modulating mode.

21. A method comprising:
providing an array of pixels having pixel elements that are actuatable between discrete states; and
selectively actuating the pixel elements between the states in a modulating mode or a static mode.

22. The method of claim 21 further comprising selecting either the modulating mode or the static mode based at least upon a source of power for the apparatus.

23. The method of claim 21 further comprising selecting either the modulating mode or the static mode based at least upon a level of power in a power storage device.

24. The method of claim 21 further comprising selecting either the modulating mode or the static mode based at least upon content of an image to be formed by the pixels.

25. The method of claim 21 further comprising operating in a hybrid mode by actuating a first portion of the pixels using the static mode and a second portion of the pixels using the modulating mode.

26. A method comprising:
grouping pixels having interferometric elements actuatable between states into super-pixels based at least upon a content of an image to be formed by the pixels; and
statically retaining elements in one of the states to form the image.

27. The method of claim 26 further comprising:
grouping pixels forming an edge in the image into a first group having a first size and grouping pixels not forming the edge in the image into a second group having a second larger size.

28. The method of claim 26 further comprising:
grouping pixels forming a first color resolution portion of the image into a group having a first size and grouping pixels forming a second greater color resolution portion of the image into a second group having a second larger size.

29. An apparatus comprising:
pixels having interferometric elements actuatable between states; and means for actuating the elements to change between a modulating mode and a static mode.

30. A computer readable medium comprising:
instructions to actuate interferometric pixel elements between discrete states using either a modulating or a static mode.
